(19) United States
(12) Patent Application Publication
(10) Pub. No.: US 2014/0341531 A1
(43) Pub. Date: Nov. 20, 2014

(54) DYNAMIC VIDEO STORING METHOD AND NETWORK SECURITY SURVEILLANCE APPARATUS

(71) Applicant: VIVOTEK INC., New Taipei (TW)

(72) Inventors: Po-Chun CHEN, New Taipei (TW); Yung-Shen CHANG, New Taipei (TW)

(73) Assignee: VIVOTEK INC., New Taipei (TW)

(21) Appl. No.: 14/270,901

(22) Filed: May 6, 2014

(30) Foreign Application Priority Data
May 15, 2013 (TW) 102117233

(51) Int. Cl. H04N 9/79; G11B 31/00

(52) U.S. Cl. CPC H04N 9/7921; G11B 31/006
USPC 386/228

(57) ABSTRACT

A dynamitic video storing method and a network security surveillance apparatus are provided. The dynamitic video storing method is performed on the network security surveillance apparatus through a network. The network security surveillance apparatus includes a video capturing unit, a storage unit, and a processing unit. The network security surveillance apparatus executes the dynamitic video storing method including the following steps. First, receive a video signal. Then, determine whether a connecting status is disconnected, and determine a residual capacity of a storage unit when the connecting status is disconnected. Finally, store the video signal according to a video parameter after the video parameter for the video signal is set according to the residual capacity.

### CROSS-REFERENCE TO RELATED APPLICATIONS

This non-provisional application claims priority under 35 U.S.C. §119(a) on Patent Application No(s). 102117233 filed in Taiwan, R.O.C. on May 15, 2013, the entire contents of which are hereby incorporated by reference.

### TECHNICAL FIELD

The disclosure relates to a video storing method and a network security surveillance apparatus, more particularly to a dynamitic video storing method and a network security surveillance apparatus which may be capable of adjusting a video parameter according to the residual capacity of storage space.

### BACKGROUND

Surveillance systems are becoming common to be disposed in many places such as streets, banks, markets, and houses. Most of these surveillance systems have to perform 24-hour surveillance and store relative video files everyday.

Network surveillance systems nowadays usually have a network video recorder (NVR) which sends video files in the video streaming to a remote network video recorder through a network to store the relative video files. However, when the network connection is disconnected or not stable, the network surveillance system can not send images to the remote network video recorder through the network efficiently, resulting in the interruption of video recording and the inconvenience in use.

Furthermore, some network surveillance systems are disposed with a storage unit to overcome the interruption of video recording caused by the disconnection of the network. Since the capacity of the storage unit (e.g. hard drive disks or memory cards) in the network surveillance system is finite, it is possible for the storage unit to become full. When the storage unit becomes full and the network is still offline, the interruption of video recording will occur.

### SUMMARY

According to one or more embodiments, the disclosure provides a dynamitic video storing method for a network security surveillance apparatus. In one embodiment, the dynamitic video storing method may include the following steps. First, receive a video signal. Then, determine whether a connecting state of the network security surveillance apparatus is offline. When the connecting state is offline, a residual capacity of a storage unit in the network security surveillance apparatus may be detected. Finally, store the video signal according to a video parameter after the video parameter for the video signal is set according to the residual capacity.

According to one or more embodiments, the disclosure also provides a network security surveillance apparatus. In one embodiment, the network security surveillance apparatus may include a video capturing unit, a storage unit, and a processing unit. The video capturing unit may generate a video signal. The storage unit may store the video signal. The processing unit may couple with the video capturing unit and the storage unit, and may receive the video signal, and determine whether a connecting state is offline. When the connecting state is offline, the processing unit may further detect a residual capacity of the storage unit, and store the video signal according to a video parameter after the video parameter for the video signal is set according to the residual capacity of the storage unit.

### BRIEF DESCRIPTION OF THE DRAWINGS

The present disclosure will become more fully understood from the detailed description given herein below for illustration only, thus does not limit the present disclosure, wherein:

FIG. 1 is a schematic view of a network security surveillance apparatus according to an embodiment;

FIG. 2 is a flow chart of a dynamitic video storing method according to an embodiment;

FIG. 3 is a flow chart of the steps S203 and S204 in FIG. 2; and

FIG. 4 is a flow chart of a dynamitic video storing method according to another embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

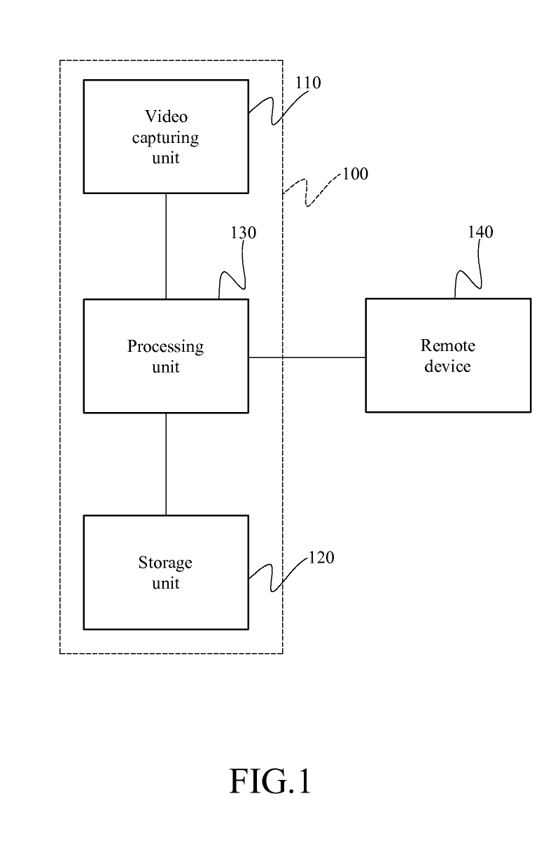

FIG. 1 is a schematic view of a network security surveillance apparatus 100 according to an embodiment. The network security surveillance apparatus 100 may include a video capturing unit 110, a storage unit 120, and a processing unit 130. The video capturing unit 110 may capture images to generate a video signal. For example, the video capturing unit 110 may be a photosensitive device. The storage unit 120 may store the video signal. For example, the storage unit 120 may be a hard drive disk (HDD) or a memory card.

The processing unit 130 may couple with the video capturing unit 110 and the storage unit 120. The processing unit 130 may receive the video signal and determine whether a connecting state is offline, to decide whether to send out the video signal through a network or store the video signal in the storage unit 120.

In one or more embodiments, when the connecting state is online, the processing unit 130 may send out the video signal through the network. When the connecting state is offline, the processing unit 130 may detect a residual capacity of the storage unit 120. Then, the processing unit 130 may store the video signal according to the video parameter after setting a video parameter for the video signal according to the residual capacity of the storage unit 120. For example, the video parameter may be a frame rate, a compression ratio, a bit rate, a resolution, or any combination thereof.

In one or more embodiments, the network security surveillance apparatus 100 may communicate with a remote device 140 through a wireless network or a cable network. For example, the remote device 140 may be a server, a network attached storage (NAS), or a network video recorder (NVR). The remote device 140 may further send commends to the network security surveillance apparatus 100 whereby the network security surveillance apparatus 100 may, according to these commands, send the video signal stored in the storage unit 120 to the remote device 140.

In the above one or more embodiments, the internal components and their connection relationship of the network security surveillance apparatus 100 are illustrated, and the operation of the network security surveillance apparatus 100 is illustrated below according to one or more embodiments.

First, after the network security surveillance apparatus 100 starts operating, the video capturing unit 110 may start capturing images to generate a video signal and send the video signal to the processing unit 130. Then, the processing unit 130 may determine whether the connecting state is offline or not. When the connecting state is not offline (i.e. online), the processing unit 130 may store the video signal in the storage unit 120 according to the preset video setting value. When the connecting state is offline, the processing unit 130 may detect the residual capacity of the storage unit 120. After setting the video parameter for the video signal according to the residual capacity of the storage unit 120, the processing unit 130 may store the video signal in the storage unit 120 according to the video parameter. Particularly, when the residual capacity of the storage unit 120 is larger than a first threshold, the processing unit 130 may set a preset video setting value as a video parameter for the video signal, and store the video signal in the storage unit 120 according to the preset video setting value.

Second, the processing unit 130 may continue to detect the residual capacity of the storage unit 120. When the residual capacity of the storage unit 120 is between the first threshold and a second threshold, the processing unit 130 may set a first video setting value as the video parameter, and store the video signal in the storage unit 120 according to the first video setting value.

Sequentially, the processing unit 130 may still continue to detect the residual capacity of the storage unit 120. When the residual capacity of the storage unit 120 is smaller than the second threshold, the processing unit 130 may set a second video setting value as the video parameter, and store the video signal in the storage unit 120 according to the second video setting value.

In one or more embodiments, the first threshold and the second threshold may be designed according to actual application requirements. In one embodiment, the first threshold may be larger than the second threshold, the first threshold may be 70 percent of the full capacity of the storage unit 120, and the second threshold may be 40 percent of the full capacity of the storage unit 120. Also, in one or more embodiments, the preset video setting value, the first video setting value, and the second video setting value may be designed according to actual application requirements. In one embodiment, the preset video setting value may be larger than the first video setting value, and the first video setting value may be larger than the second video setting value. For instance, the preset video setting value may be 15 frames per second (fps), 3 Mbps, and 1080 progressive scan (p). For example, the first video setting value may be 15 fps, 1 Mbps, and 720 p. For example, the second video setting value may be 10 fps, 500 Kbps, and a video graphics array (VGA).

In addition, when the processing unit 130 detects that the connecting state is offline, the processing unit 130 may store the video signal through the above method and further continue to determine whether the connecting state has restored to be online. In one embodiment, the processing unit 130 may perform the detection of the connecting state once every 10 seconds to determine whether the connecting state is restored or not.

When the processing unit 130 detects that the connecting state has restored to be online, the processing unit 130 may send the video signal outputted by the video capturing unit 110 to the remote device 140 according to the preset video setting value and may stop storing the video signal in the storage unit 120.

Then, after the user may send a data request message to the processing unit 130 via the remote device 140, the processing unit 130 may send the video signal stored in the storage unit 120 to the remote device 140 in response to the data request message. In this way, when the network is offline, the remote device 140 may be capable of obtaining images captured by the network security surveillance apparatus 100, and then link up these images. Therefore, the video recoding may not be interrupted, resulting in the higher convenience in use.

After the connecting state has restored to be online, the processing unit 130 may send the video signal to the remote device 140 according to the above method and further continue to determine whether the connecting state is offline, to decide whether to send out the video signal through the network or to store the video signal in the storage unit 120.

On the other hand, since the capacity of the storage unit 120 is finite and the duration of the interruption of the network connection is then too long, the storage unit 120 may run out of its capacity. Therefore, when the capacity of the storage unit 120 has run out, the processing unit 130 may operate according to the following one or more embodiments.

In one or more embodiments, when the residual capacity of the storage unit 120 is zero (that is, the storage unit 120 is full), and the connecting state has not restored to be online yet, the processing unit 130 may adjust the video signal stored in the storage unit 120 according to the storing time of the video signal. In one embodiment, the processing unit 130 may, according to the storing time, delete the video signal first stored in the storage unit 120 (i.e. the oldest files), or replace the video signal first stored in the storage unit 120 (i.e. the oldest files) with the latest stored video signal in the storage unit 120 (i.e. the newest file). Therefore, the network security surveillance apparatus 100 may be able to continue the video recording.

In one or more other embodiments, conditions for the processing unit 130 to delete files may be able to be edited in order to increase the available time for the seamless video recording. For instance, the processing unit 130 may first delete files which are not generated in the seamless video recording. That is, the processing unit 130 may analyze the importance of each file to delete files with lower importance. Therefore, the residual capacity of the storage unit 120 for the video recording may increase.

In one embodiment, the processing unit 130 may reprocess the files in the storage unit 120. In other words, the processing unit 130 may further adjust the image quality of each file in the storage unit 120, such as reducing the fps or bit rate of each file, thereby increasing the residual capacity of the storage unit 120 for the video recording.

On the other hand, when the connecting state becomes online, the processing unit 130 may output the video signal stored in the storage unit 120 to the remote device 140 according to the request of the remote device 140. After the processing unit 130 outputs the video signal stored in the storage unit 120 to the remote device 140, the processing unit 130 may detect the residual capacity of the storage unit 120 to determine whether to delete the video signal stored in the storage unit 120.

In one embodiment, when the processing unit 130 gets that the residual capacity of the storage unit 120 is smaller than a specific level (such as 20 percent of the full capacity of the storage unit 120), the video signals stored in the storage unit 120 may be adjusted or deleted according to the above method, to increase the residual capacity of the storage unit 120.

In this way, the network security surveillance apparatus 100 may efficiently extend the available time for the video recording, prevent the video recording from the interruption, and be more convenient to use.

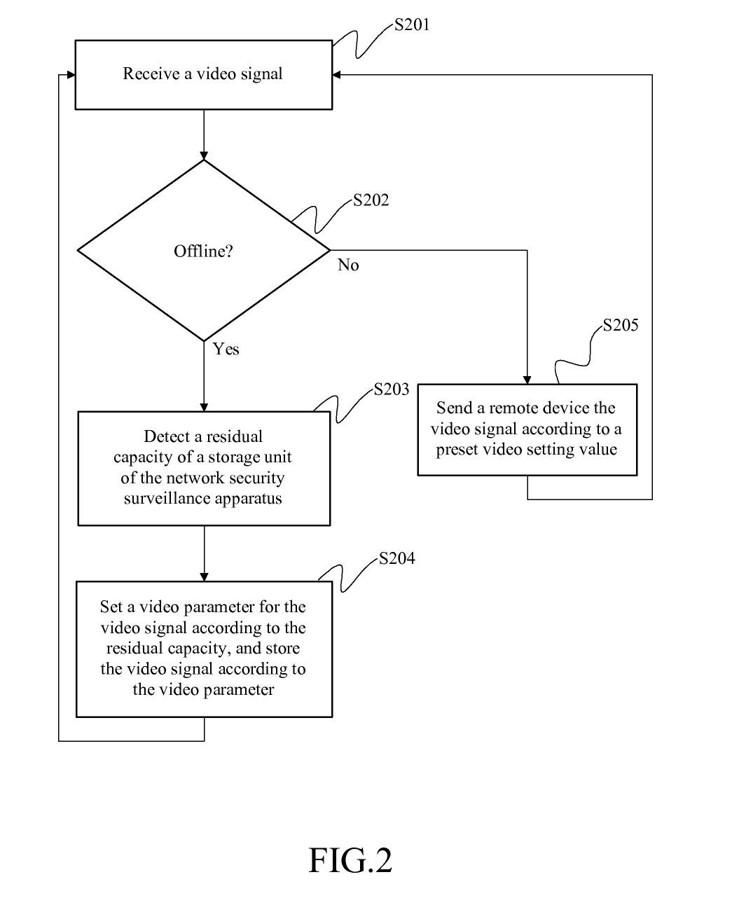

In view of the above one or more embodiments related to the network security surveillance apparatus in the disclosure, they may be summarized in a dynamitic video storing method. FIG. 2 is a flow chart of a dynamitic video storing method according to an embodiment. The dynamitic video storing method may be applied to a network security surveillance apparatus and be capable of being repeated. First, as shown in step S201, a video signal may be received. As shown in step S202, whether the connecting state of the network security surveillance apparatus is offline may be determined.

As shown in step S203, when the connecting state is offline, the residual capacity of a storage unit in the network security surveillance apparatus may be detected. As shown in step S204, the video signal may be stored according to a video parameter after the video parameter for the video signal is set according to the residual capacity, and then the process may be proceed to the step S201. When the connecting state is not offline, the video signal may be sent to a remote device according to a preset video setting value, as shown in step S205, and then the process may proceed to the step S201.

Through repeating the steps S201 to S204 and steps S201 to S205, the disclosure may efficiently avoid of the interruption of the video recording caused by the disconnection of the network.

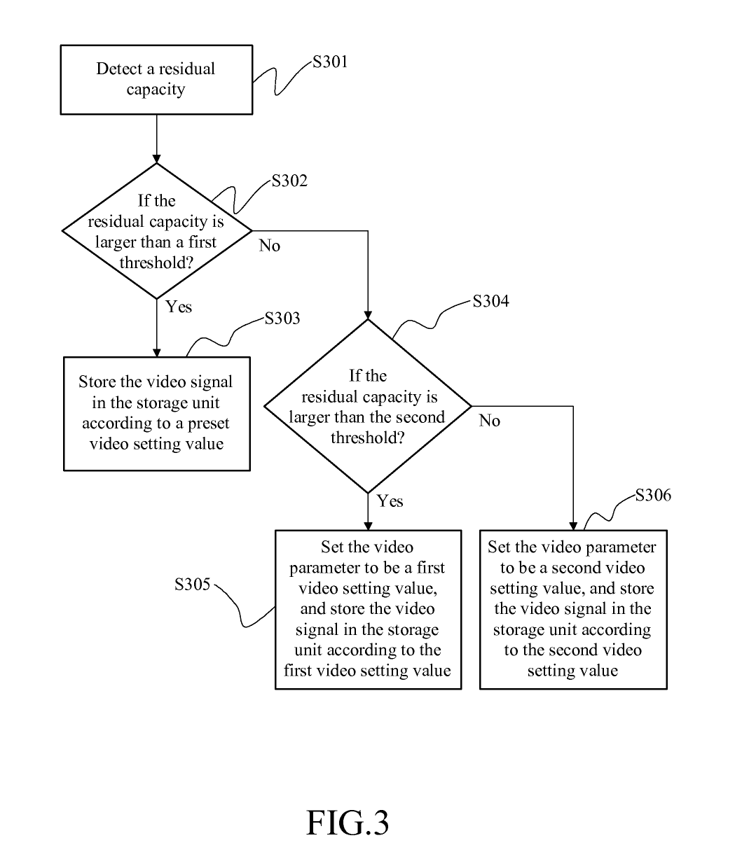

FIG. 3 is a flow chart of the steps S203 and S204 in FIG. 2. First, as shown in step S301, i.e. the step S204, the residual capacity is detected. As shown in step S302, whether the residual capacity is larger than a first threshold may be determined.

When the residual capacity is larger than the first threshold, the video signal may be stored in the storage unit according to the preset video setting value, as shown in step S303. In contrast, when the residual capacity is not larger than the first threshold, whether the residual capacity is larger than a second threshold may be determined, as shown in step S304.

When the residual capacity is larger than the second threshold, a first video setting value may be set as the video parameter, and the video signal may be stored in the storage unit according to the first video setting value, as shown in step S305. Otherwise, when the residual capacity is not larger than the second threshold, a second video setting value may be set as the video parameter, and the video signal is stored in the storage unit according to the second video setting value, as shown in step S306.

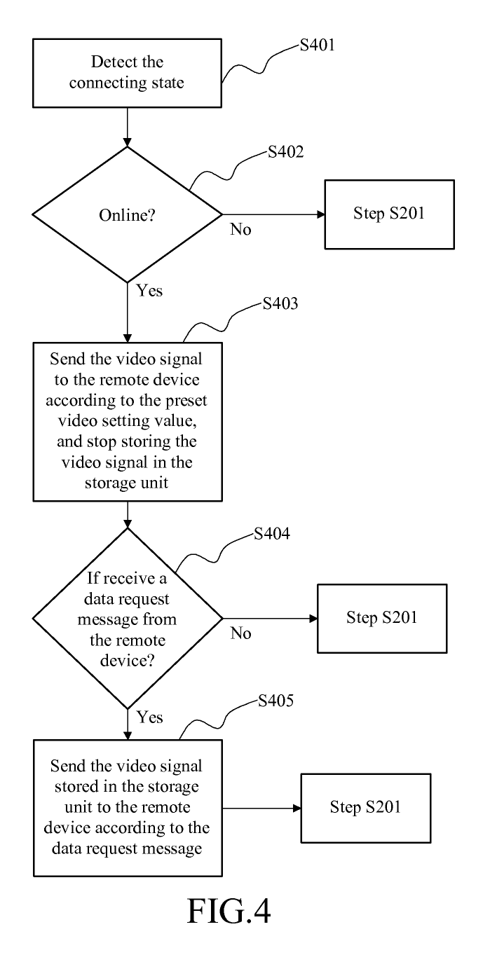

FIG. 4 is a flow chart of a dynamitic video storing method according to another embodiment. The steps in FIG. 4 may follow the step S204 in FIG. 2. In other words, step S401 in FIG. 4 may follow the step S204 in FIG. 2. As shown in step S401, the connecting state is detected. As shown in step S402, whether the connecting state has restored to be online may be determined.

When the connecting state has restored to be online, the video signal may be sent to the remote device according to the preset video setting value, instead of being stored in the storage unit, as shown in step S403. Following the step S403, whether a data request message outputted by the remote device is received may be determined, as shown in step S404. When the data request message is not received, the process may proceed to the step S201. In contrast, when the data request message is received, the video signal stored in the storage unit may be sent to the remote device according to the data request message, as shown in step S405. Following step S405, the process may proceed to the step S201.

Otherwise, following step S402, when the connecting state does not restore to be online, the process may proceed to step S201.

As set forth above, the disclosure may employ the processing unit to continue determining whether the connecting state of the network security surveillance apparatus is offline, so as to decide the processing scheme for the video signal generated by the video capturing unit. When the connecting state of the network security surveillance apparatus is offline, the processing unit may further detect the residual capacity of the storage unit in the network security surveillance apparatus, dynamically set the video parameter for the video signal according to the residual capacity, and store the video signal in the storage unit according to the video parameter.

Based on the same recording time period, the file size of the video signal in the first video setting value may be smaller than the video signal in the preset video setting value, but larger than the video signal in the second video setting value. Moreover, the preset video setting value may be defined by users when the network security surveillance apparatus starts up. When the network is disconnected, the residual capacity of the storage unit in the network security surveillance apparatus may be detected, and the data quantity of video files may dynamically be reduced. Therefore, the available time for the video recording may be extended to avoid of the interruption of the video recording and to increase the convenience in use.

What is claimed is:

1. A dynamitic video storing method for a network security surveillance apparatus, comprising:
receiving a video signal;
determining whether a connecting state of the network security surveillance apparatus is offline;
when the connecting state is offline, detecting a residual capacity of a storage unit of the network security surveillance apparatus; and
setting a video parameter for the video signal according to the residual capacity, and storing the video signal according to the video parameter.

2. The dynamitic video storing method according to claim 1, wherein the step of setting the video parameter for the video signal according to the residual capacity, and storing the video signal according to the video parameter comprises:
when the residual capacity is larger than a first threshold, storing the video signal in the storage unit according to a preset video setting value.

3. The dynamitic video storing method according to claim 2, wherein the step of setting the video parameter for the video signal according to the residual capacity, and storing the video signal according to the video parameter further comprises:
when the residual capacity is between the first threshold and a second threshold, setting the video parameter to be a first video setting value, and storing the video signal in the storage unit according to the first video setting value; and
when the residual capacity is smaller than the second threshold, setting the video parameter to be a second video setting value, and storing the video signal in the storage unit according to the second video setting value,
wherein the first threshold is larger than the second threshold.

4. The dynamitic video storing method according to claim 2, wherein the video parameter comprises a frame rate, a compression ratio, a bit rate, a resolution, or a combination thereof.

5. The dynamitic video storing method according to claim 2, further comprising:
determining whether the connecting state is restored to be online;
when the connecting state is not online yet, repeating the step of detecting the residual capacity of the storage unit; and
when the connecting state is restored to be online, sending a remote device the video signal according to the preset video setting value, and stopping storing the video signal in the storage unit.

6. The dynamitic video storing method according to claim 5, wherein after the video signal is sent to the remote device according to the preset video setting value and is stopped stored in the storage unit, the dynamitic video storing method further comprises:
receiving a data request message outputted by the remote device; and
sending the remote device the video signal stored in the storage unit according to the data request message.

7. The dynamitic video storing method according to claim 1, wherein the step of determining whether the connecting state of the network security surveillance apparatus is offline comprises:
when the connecting state is online, sending the video signal to a remote device.

8. A network security surveillance apparatus, comprising:
a video capturing unit, for generating a video signal;
a storage unit, for storing the video signal; and
a processing unit, coupled with the video capturing unit and the storage unit, for receiving the video signal, determining whether a connecting state is offline, detecting a residual capacity of the storage unit when the connecting state is offline, setting a video parameter for the video signal according to the residual capacity, and storing the video signal according to the video parameter.

9. The network security surveillance apparatus according to claim 8, wherein when the residual capacity is larger than a first threshold, the processing unit stores the video signal in the storage unit according to a preset video setting value.

10. The network security surveillance apparatus according to claim 9, wherein when the residual capacity is between the first threshold and a second threshold, the processing unit sets the video parameter to be a first video setting value, and stores the video signal in the storage unit according to the first video setting value; when the residual capacity is smaller than the second threshold, the processing unit sets the video parameter to be a second video setting value, and stores the video signal in the storage unit according to the second video setting value; and the first threshold is larger than the second threshold.

11. The network security surveillance apparatus according to claim 9, wherein the video parameter comprises a frame rate, a video signal compression ratio, a video signal bit rate, a video signal resolution, or a combination thereof.

12. The network security surveillance apparatus according to claim 9, wherein the processing unit further determines whether the connecting state is restored to be online; when the connecting state has not been restored to be online yet, the processing unit continues to store the video signal in the storage unit according to the video parameter after the video parameter for the video signal is set according to the residual capacity; and when the connecting state is restored to be online, the processing unit sends the video signal to a remote device according to the preset video setting value and stops storing the video signal in the storage unit.

13. The network security surveillance apparatus according to claim 12, wherein after sending the video signal to the remote device and stopping storing the video signal in the storage unit, the processing unit receives a data request message outputted by the remote device, and sends the video signal stored in the storage unit to the remote device according to the data request message.

14. The network security surveillance apparatus according to claim 8, wherein when the connecting state is online, the processing unit sends the video signal to a remote device.
